(19) United States
(12) Patent Application Publication
(10) Pub. No.: US 2017/0085085 A1
(43) Pub. Date: Mar. 23, 2017

(54) METHOD AND DEVICE FOR REDUCING VOLTAGE FLUCTUATIONS IN A SUPPLY NETWORK

(71) Applicant: SIEMENS AKTIENGESELLSCHAFT, MUENCHEN (DE)

(72) Inventors: MARTIN PIESCHEL, NUERNBERG (DE); JONAS PINKWART, FUERTH (DE); KWOK TUNG WONG, PUSCHENDORF (DE)

(21) Appl. No.: 15/311,600

(22) PCT Filed: Apr. 9, 2015
(86) PCT No.: PCT/EP2015/057690

§ 371 Date: Nov. 16, 2016

(30) Foreign Application Priority Data
May 16, 2014 (EP) 14168654.3

(51) Int. Cl. H02J 3/16; H02J 3/01; H02J 3/24

(52) U.S. Cl. CPC H02J 3/16; H02J 3/24; H02J 3/01

(57) ABSTRACT

Voltage fluctuations in a supply network are intended to be reduced efficiently and cost-effectively. According to the method, a current flowing into a load is measured and a corresponding current measurement signal is obtained. The voltage fluctuations are reduced with the aid of a TCR, which constitutes a thyristor-controlled reactance, and a VSC, which constitutes a voltage source converter. The current measurement signal or a corresponding variable is divided into a first portion and a second portion depending on a predefined absolute limit value. The TCR is controlled on the basis of the first portion and the VSC is controlled on the basis of the second portion. Alternatively, the TCR can be controlled with the load current measurement signal and the VSC can be controlled with a sum of the load current measurement signal and a TCR current measurement signal.

The present invention relates to a method for reducing voltage fluctuations in a supply network, which are caused by operating a load from the supply network. In this case, a current flowing into the load is measured, as a result of which a corresponding current measurement signal is obtained. Voltage fluctuations are reduced with the aid of a TCR (thyristor controlled reactor) and with the aid of a VSC (voltage source converter), preferably using filter circuits which are permanently connected. The present invention also relates to a corresponding compensation device.

High-performance furnaces (for example arc furnaces) are distinguished by the fact that they have severe power fluctuations. These power fluctuations have an effect on the corresponding supply network. The dissertation by T. Ellinger: “Entwicklung eines hybriden Kompensatorkonzepts für einen Drehstromlichtbogenofen”, Technical University of Ilmenau, April 2, 2004 discloses appropriate possible ways of compensating for the disturbances caused by a furnace on the basis of a hybrid filter concept. The active part of the compensator consists of a thyristor-controlled reactive current controller (TCR system) and a parallel active filter. The TCR system compensates for the fundamental reactive power of the furnace. It is also responsible for reducing flicker. An active filter is used to compensate for the distortion reactive power of the overall system.

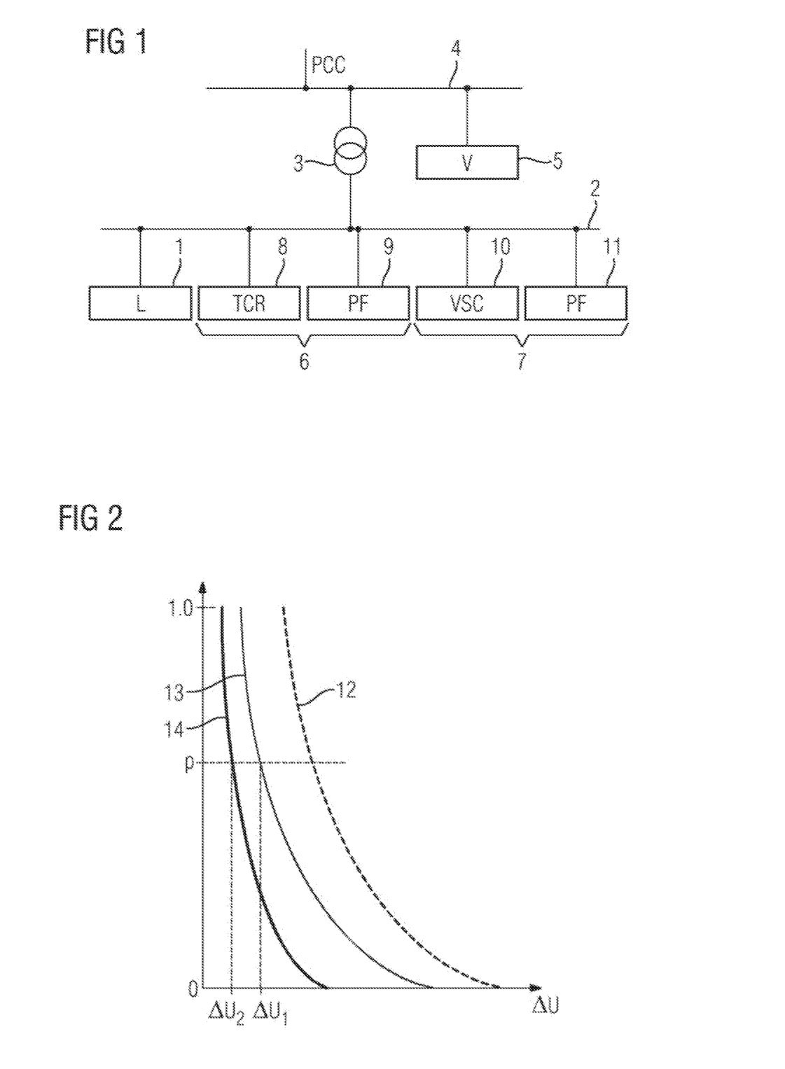

Internally, a power system according to FIG. 1 having an electrical arc furnace as a greatly fluctuating load 1 is known. The load 1 is supplied, for example, via a medium-voltage network 2 (for example 10 to 35 kV). The medium-voltage network 2 is in turn supplied via a step-down transformer 3 connected to a high-voltage network 4. Connection is effected at a so-called “Point of Common Coupling” PCC of the high-voltage network. A further load (V) 5 is symbolically connected to the high-voltage network 4.

In order to compensate for or reduce voltage fluctuations in the medium-voltage network 2 and therefore also in the high-voltage network 4, a so-called SVC 6 (static VAR compensator) and a STATCOM 7 (static synchronous compensator, that is to say a power converter in pulsed operation for producing inductive or capacitive reactive power) are coupled to the medium-voltage network 2 in addition to the load 1. In this case, the SVC 6 comprises a TCR 8 and a passive filter circuit 9. Both the TCR 8 and the passive filter circuit 9 are directly connected to the medium-voltage network 2.

The STATCOM 7 comprises a VSC 10 (voltage source converter) and likewise a passive filter circuit 11. Both the VSC 10 and the passive filter circuit 11 are directly coupled to the medium-voltage network 2. Therefore, together with the TCR 8 and the passive filter circuit 9, they are parallel to the load 1.

As indicated above, the large load fluctuations at the coupling point PCC, which occur in high-performance furnaces for example, should be compensated for by means of a compensation system. Such a compensation system would be an SVC 6 which comprises a TCR 8 and a harmonic filter or a set of harmonic filters 9 and has been known for more than 30 years. Such an SVC 6 is suitable for reducing disturbances from slowly changing loads. However, if the loads change rapidly, SVCs can reduce voltage disturbances only inadequately. Instead of a TCR 8, a VSC 10 is then typically used. The latter is not dependent on the trigger delays of thyristors and therefore reacts more quickly. In addition, it does not have any dead time caused by the property of the thyristors of being able to only switch on but not off. However, it is generally considerably more expensive.

The effect of compensation and therefore the reduction in the voltage fluctuations U are indicated in FIG. 2. There, curves 12, 13 and 14 of the probability p are plotted against the voltage fluctuations U. The curve 12 shows the probability of voltage fluctuations without compensation. The curve 13 represents the probability of voltage fluctuations if compensation is carried out using a single SVC (or TCR) which is suitable for slow load changes. Finally, the curve 14 represents the probability of voltage fluctuations in the case of compensation using a single STATCOM (or VSC filter combination) which is suitable for fast load changes. In this case, the individual probability p represents the fact that a voltage fluctuation exceeds a predetermined U value.

For the same nominal power, the cost ratio of the VSC to the TCR and to passive filter circuits is approximately 4:1:1. The ratio of the performance of a system having a VSC to that of the system having a TCR is approximately 2:1, which corresponds approximately to the ratio U1:U2 from FIG. 2.

FIG. 2 therefore shows the voltage fluctuations and their probabilities. For example, the probability of the voltage fluctuation being higher than U1 is p according to curve 13 when a single SVC is used. When a single STATCOM is used, the voltage fluctuation is above U2 for the same probability. This means that the STATCOM 7 is more powerful than the SVC 6.

By way of clarification, it is pointed out that FIG. 2 does not show that each voltage fluctuation recorded by means of measurements has a fluctuation frequency which is between 0.5 Hz and 25 Hz. The fluctuation frequency generally means the number of cycles per second in which the voltage rises and falls. An SVC reacts well to load fluctuations up to a fluctuation frequency of 5 Hz and also reacts with a certain amount of success between 5 and 10 Hz. However, its performance above 10 Hz is low. In contrast, a STATCOM reacts well to load fluctuations in the entire fluctuation frequency range. The tolerance with respect to voltage fluctuations is strictest at approximately 9 Hz since the eye or brain reacts most strongly to lighting fluctuations in this frequency range. Since the STATCOM is superior to the SVC not only in this frequency range but generally, the curve of the STATCOM is to the left of the curve of the SVC in FIG. 2.

If the load is slightly above the load-bearing capacity of a STATCOM, the curve 14 of the STATCOM in FIG. 2 will move slightly to the right, with the result that the disturbance limit value is not reached under certain circumstances. In order to shift the curve to the left again and reach the limit value, it is necessary to increase the load-bearing capacity of the compensation system. A cost advantage exists in this case if the performance of the compensation system is increased using a TCR 8 instead of a second VSC 10. In such a case, it is important for the TCR and the VSC to be operated in a coordinated mariner in order to achieve the best performance result.

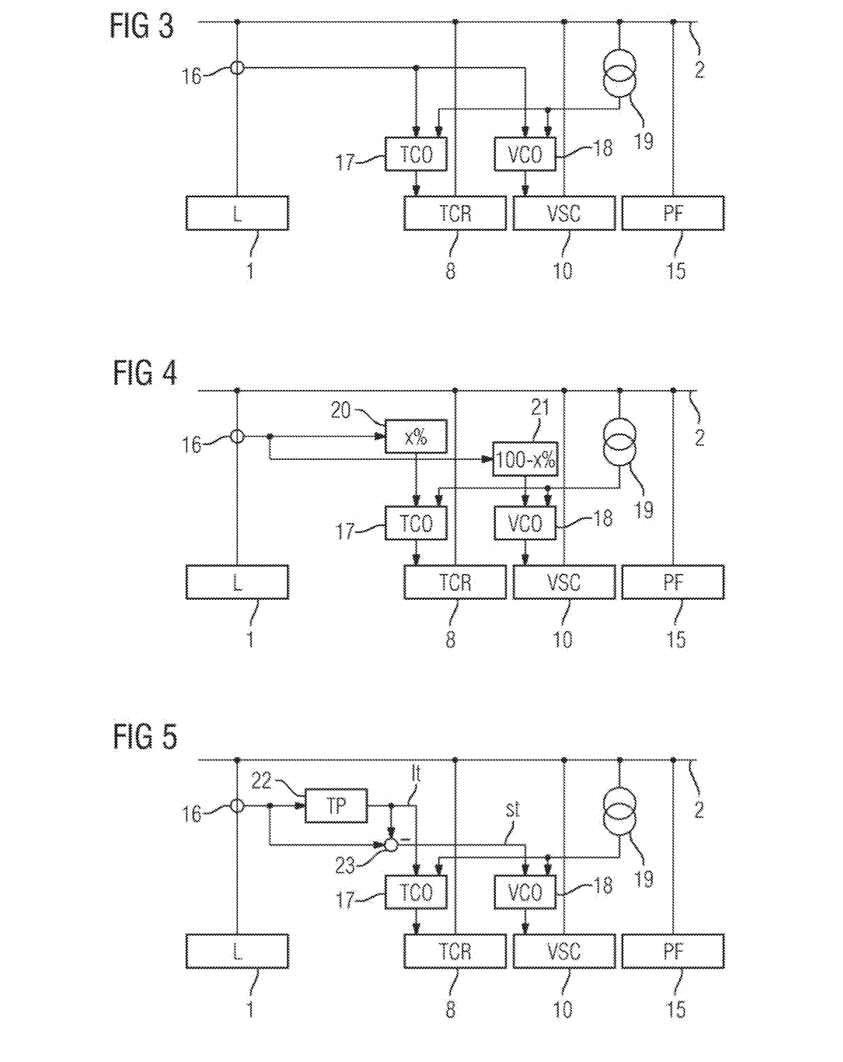

Certain combined operating modes of the TCR, VSC and passive filter circuits are already known. For example, the TCR and the VSC can be operated independently of one another, which is illustrated in FIG. 3. In terms of the basic structure, the system illustrated in FIG. 3 corresponds to that from FIG. 1. However, the high-voltage network 4 is not illustrated for reasons of simplicity. The load 1 is connected to the medium-voltage network 2. In parallel with the load, the TCR 8, the VSC 10 and a passive filter circuit 15 are connected to the medium-voltage network 2. In principle, however, it is not important how high. the voltage is in the network 2.

FIG. 3 shows the control or regulation of the TCR/VSC combination together with the filter circuit 15 in more detail. In this case, it is advantageous, but not necessary, for the filter circuit 15 to be passive.

An ammeter 16 is used to measure the current flowing into the load I from the medium-voltage network 2. A corresponding current measurement signal is supplied to a TCR control unit 17 (TCO) and to a VSC control unit 18 (VCO). Both control units 17 and 18 also receive voltage measurement signals from a voltmeter 19 with regard to the voltage in the medium-voltage network 2. The TCR control unit 17 generates a control signal for the TCR 8 and the VSC control unit 18 generates a control signal for the VSC 10 from the current and voltage measurement signals.

In the example from FIG. 3, the TCR 8 and the VSC 10 operate independently of one another. A predetermined fraction of the load current is compensated for by the TCR and the remainder is compensated for by the VSC 10. This method only partially uses the fast responsiveness of the VSC 10 and therefore leads to suboptimal results.

In one development according to FIG. 4, the VSC 10 is used as an active filter. The TCR 8 reduces the fundamental fluctuations of the voltage, while the VSC 10 eliminates only the harmonics. The basic structure of this system is represented in FIG. 3, and so reference is made to the description there. However, in the example from FIG. 4, provision is additionally made for the current measurement signal to be divided. A certain portion, namely x percent of the measured value, is supplied to the TCR control unit 17. A multiplier 20, for example, can be used for this purpose. A further multiplier 21 transmits the remainder of the current intensity value in the current measurement signal to the VSC control unit 18 which in turn outputs a corresponding control signal to the VSC 10. With regard to the further functionality of the system, reference is made to the description of FIG. 3.

The load fluctuations may change dynamically. The known systems are therefore overexerted and it is not possible to achieve any optimal compensation which still does not require two VSCs, especially in a load range.

The object of the present invention is therefore to provide a method and a compensation device which make it possible to reduce voltage fluctuations more efficiently using a TCR and a VSC.

According to the invention, this object is achieved by means of a method for reducing voltage fluctuations in a supply network, which are caused by operating a load from the supply network, by
measuring a current flowing into the load, as a result of which a corresponding current measurement signal is obtained,
reducing the voltage fluctuations with the aid of a TCR, and
reducing the voltage fluctuations with the aid of a VSC,
and
dividing the current measurement signal or a corresponding variable into a first portion and a second portion on the basis of a predefined absolute limit value,
controlling the TCR on the basis of the first portion, and
controlling the VSC on the basis of the second portion.

The compensation is therefore advantageously achieved in a parallel manner by means of a TCR and a VSC, both being controlled dynamically. Therefore, the TCR and the VSC respectively do not provide a rigid portion of reactive power for compensation, but rather the respective portion is controlled on the basis of the nature of current measurement signal representing the current flowing into the load. In this case, a predefined absolute limit value is used, on the basis of which the current measurement signal is analyzed. The TCR and the VSC are controlled according to the analysis result.

In one embodiment, the predefined absolute limit value II represents a cut-off frequency. The voltage fluctuations are therefore categorized according to their frequency. Portions at a higher frequency can therefore be handled differently to portions at lower frequencies.

In particular, frequencies of the first portion may be below the cut-off frequency and all frequencies of the second portion may be above the cut-off frequency. Low-frequency portions of the current measurement signal are therefore used to control the TCR, whereas high-frequency portions of the current measurement signal are used to control the VSC. The cut-off frequency can be between 0 and 8 Hz, in particular between 1 and 5 Hz, for example. This makes it possible to ensure that the portions are efficiently reduced by the VSC at approximately 9 Hz, to which the human organism has a very sensitive reaction in the case of lighting.

Alternatively, the predefined limit value can also represent an intensity of the current or a power. The reduction of the voltage fluctuations on account of the reactive powers on the basis of the respectively measured current or the measured power can therefore be carried out proportionately by one method or by the other method.

The first portion is preferably formed by components of the current measurement signal or of the corresponding variable which are above the predefined limit value. Accordingly, the second portion is then formed by components of the current measurement signal or of the corresponding variable which are below the predefined limit value. The VSC is therefore used as long as the current or the power of the load falls below the predefined limit value. First portions which are above this limit value are reduced by the TCR.

The above object is also achieved, according to the invention, by means of a compensation device for reducing voltage fluctuations in a supply network, which are caused by operating a load from the supply network, having
a measuring device for measuring a current flowing into the load, as a result of which a corresponding current measurement. signal can be provided,
a TCR for reducing the voltage fluctuations, and
a VSC for reducing the voltage fluctuations,
also comprising
a splitter device for dividing the current measurement signal or a corresponding variable into a first portion and a second portion on the basis of predefined absolute limit value,
a first control device for control the TCR on the basis of the first portion, and
a second control vice for controlling the VSC on the basis of the second portion.

In this case too, the current measurement signal or the corresponding variable is advantageously divided on the basis of a predefined absolute limit value, that is to say in an intelligent manner by a splitter device. Highly dynamic operations of average power, in particular, can therefore be handled. more effectively with regard to voltage smoothing in the supply network.

In this case too, the splitter device can have a frequency splitter, and the predefined absolute limit value is a cut-off frequency of the frequency splitter. This results in the above-mentioned advantages.

In particular, the splitter device can have a limiter which uses the predefined limit value to limit a control value for the VSC. In particular, the capacity of the VSC can therefore be used fully or in an improved manner.

The supply network can also be loaded with a filter circuit which interacts with the TCR and the VSC in order to reduce the voltage fluctuations. In particular, the filter circuit may be passive, may act capacitively and may be tuned to the TCR and the VSC. This makes it possible to provide a cost-effective filter circuit which compensates for the reactive powers caused by the load using the inductances of the TCR and the VSC.

The above object is also achieved, according to the invention, by means of a method for reducing voltage fluctuations in a supply network, which are caused by operating a load from the supply network, by
measuring a current between the load and the supply network, as a result of which a corresponding first current measurement signal is obtained,
reducing the voltage fluctuations with the aid of a TCR, and
reducing the voltage fluctuations with the aid of a VSC,
measuring a current between the TCR and the supply network, as a result of which a corresponding second current measurement signal is obtained, and
controlling the TCR on the basis of the first current measurement signal, and
controlling the VSC on the basis of the first and second current measurement signals.

In addition, the invention provides a compensation device for reducing voltage fluctuations in a supply network, which are caused by operating a load from the supply network, having
a first measuring device for measuring a current between the load and the supply network, as a result of which a corresponding first current measurement signal can be provided,
a TCR for reducing the voltage fluctuations, and
a VSC for reducing the voltage fluctuations,
a second measuring device for measuring a current between the TCR and the supply network, as a result of which a corresponding second current measurement signal can be provided,
a first control device for controlling the TCR on the basis of the first current measurement signal, and
a second control device for controlling the VSC on the basis of the first and second. current measurement signals.

The TCR is therefore advantageously primarily responsible for reducing the voltage fluctuations. Only that portion of the voltage fluctuations which is not managed by the TCR is assumed by the VSC.

The VSC is preferably controlled on the basis of a sum of the first and second current. measurement signals. It is therefore possible for the compensation current of the VSC to correspond to the difference between a total (capacitive) filter current and the (inductive) load current together with the (inductive) TCR current.

If necessary, a voltage of the supply network can also be measured, with the result that the voltage fluctuations are also reduced on the basis of the measured voltage. This voltage measurement using a suitable voltage measuring device, in addition to the current measurement, is particularly advantageous since flicker and reactive power compensation can then be based on calculated powers.

The present invention is now explained in more detail using the accompanying drawings, in which:

FIG 1 shows a supply system having a disruptive load, compensation means and other loads;

FIG. 2 shows probability distributions for voltage fluctuations above a predetermined voltage fluctuation;

FIG. 3 shows a control system having a combination of a TCR and a VSC;

FIG. 4 shows control system having a TCR for reducing voltage fluctuations and a VSC for reducing harmonic disturbances;

FIG. 5 shows a circuit diagram of control of the TCR and the VSC according to the invention by dividing the activity of the TCR and the VSC on the basis of the frequency of the voltage fluctuations;

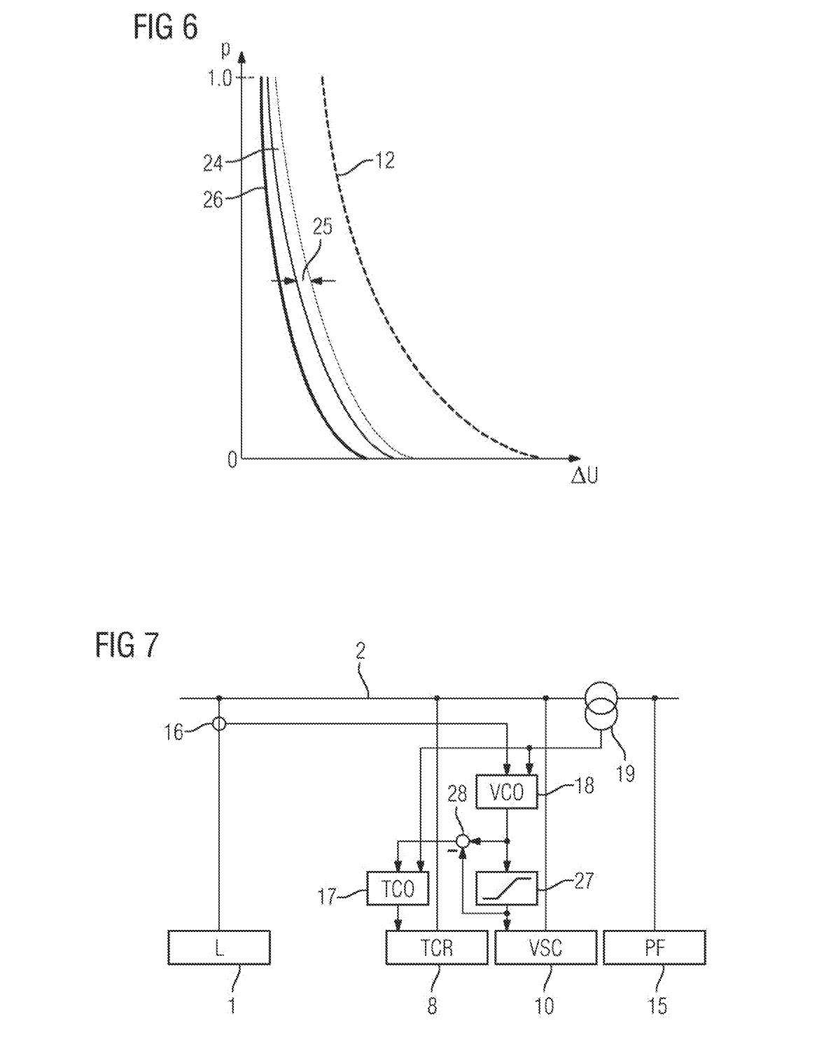

FIG. 6 shows a graph of probabilities of voltage fluctuations during control operations according to the invention;

FIG. 7 shows an alternative embodiment to FIG. 5 with a limiter;

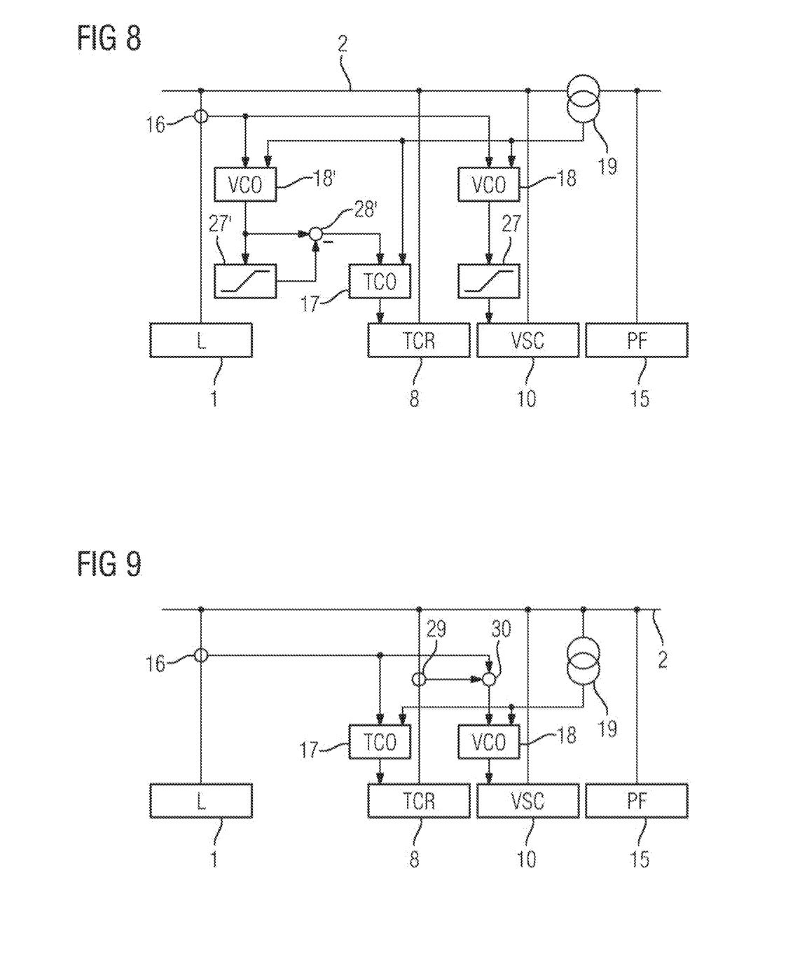

FIG. 8 shows a further development of the exemplary embodiment from FIG. 7 with a further limiter; and

FIG. 9 shows an alternative embodiment to FIG. 5 with TCR current measurement.

The exemplary embodiments described in more detail below are preferred embodiments of the present invention. For the description of these embodiments, reference is additionally made to the above explanations with respect to FIGS. 1 to 4. Only the differences are highlighted in more detail below.

The present invention provides a plurality of different methods for operating the TCR and the VSC (or the SVC and the STATCOM) in a coordinated manner. These methods relate to situations in which the load requirements are above the compensation ability of a single STATCOM and are below the compensation ability of two STATCOMs. These methods are naturally not restricted to these situations alone.

According to the first example according to the invention which is represented, in principle, in FIG. 5, the compensation requirement is divided into a first, slow part lt, which is to be compensated for by the TCR 8, and a remaining, second, fast part st, which is to be compensated for by the VSC 10. The division is carried out by a splitter device 22, 23 which comprises a low-pass filter (TP) 22 here. The signal at the output of the low-pass filter 22 has only the slow or low-frequency portions lt of the current measurement signal. The signal lt is used as the input signal for the TCR control unit 17 which therefore uses only the slow portions of the current measurement signal, in addition to the voltage measurement signal from the voltmeter 19 (cf. descriptions with respect to FIGS. 3 and 4), to control the TCR 8. The slow portion lt at the output of the low-pass filter 22 is also supplied to the subtractor 23 which subtracts this slow portion from the entire current measurement signal, thus resulting in the fast portion st. This fast portion st is used to control the VSC control unit (VCO) 18 which likewise receives the voltage measurement signal from the voltmeter 19. The VSC control unit 18 then controls the VSC 10 on the basis of the fast portion st of the current measurement signal.

The cut-off frequency of the splitter device is preferably such that current or voltage fluctuations of 9 Hz and above are represented in the second portion, namely the fast portion st. Accordingly, the cut-off frequency could be 5 Hz, for example.

During operation of the compensation device illustrated in FIG. 5 and during the corresponding method, the fast responsiveness of the VSC 10 is therefore used to compensate for the critical 9 Hz load fluctuations. Accordingly, the TCR 8 is used only for slow load fluctuations. This means that, on account of its slow triggering and extinction behavior, the TCR 8 is used only to compensate for slow fluctuations in the reactive power.

An estimation of the performance of the method and of the compensation device according to FIG. 5 with the frequency division can be gathered from FIG. 6. The probability of a voltage fluctuation in a fictitious system being greater than a particular U and of no compensation taking place is revealed by the curve 12, as in FIG. 2. If compensation now takes place according to the above method with frequency splitting, that is to say using a TCR, a VSC, a frequency splitter and a passive filter circuit, the estimated probability is in the region 24. Accordingly, an estimated bandwidth 25 results for the new method. In principle, it would naturally be desirable if the same performance as that of two STATCOMs were achieved by the combined operation of the SVC and the STATCOM. The probability of voltage fluctuations in the event of compensation using two STATCOMs results from curve 26. According to this graph from FIG. 6, although the probabilities of voltage fluctuations with the compensation according to the invention are considerably below those in systems without compensation, they are still slightly above the probabilities during compensation using two STATCOMs.

The above probability curves and, in particular, the band 24 and the bandwidth 25 also approximately apply to the second method described below and the corresponding second compensation device in the exemplary embodiments according to FIGS. 7 and 8.

With respect to the description of FIGS. 7 and 8, reference is again made to the description of all preceding figures where the same elements are mentioned. The following description concentrates only on the differences. In the second method, the VSC 10 compensates for the reactive load in the normal situation. During these phases, the TCR 8 opposes the capacitively acting passive filter circuit 15 with a constant inductive power. The TCR 8 provides compensation only when the voltage source converter VSC 10 reaches its output limit.

Specifically, this is achieved in the compensation device according to FIG. 7 by virtue of the fact that the current measurement signal from the ammeter 16 is made available to the VSC control unit 18. On the basis of said current measurement signal and on the basis of the voltage measurement signal from the voltmeter 19, the VSC control unit 18 generates a control signal which is supplied to a splitter device 27, 28. The splitter device comprises a limiter 27 here. The control signal from the VSC control unit 18 represents the current measurement signal or a corresponding variable. If the current measurement signal is therefore high, this is accordingly represented in the control signal from the VSC control unit 18. The limiter 27 provides limitation and outputs a limit value predefined by it when the value of the control signal exceeds this limit value. The VSC 10 is then controlled only using the limit value and runs at the intended maximum power.

The splitter device also comprises a subtractor 28 which is supplied with the control signal from the VSC control unit (VCO) 18 and with the output value from the limiter 27. If the control value from the VSC control unit 18 is above the limit value, the difference between the two signals is positive and this difference value is supplied to the TCR control unit (TCO) 17 for further control of the TCR 8 also on the basis of the voltage measurement signal from the voltmeter 19. In contrast, if the value of the control signal from the VSC control unit 18 is less than the limit value of the limiter 27, the limiter 27 is virtually ineffective and controls the VSC 10 using the signal from the VSC control unit 18. The output signal from the subtractor 28 then has the value 0 since the input signal and the output signal of the limiter 27 are the same. Accordingly, the TCR 8 is controlled such that it does not compensate for any reactive power. In this case, the reactive power is therefore compensated for completely by the VSC 10.

In one preferred exemplary embodiment, the capacitively acting passive filter circuit 15 is designed in such a manner that it can completely counteract the inductive output power of the TCR 8 and the VSC 10, the constant inductive power of the TCR 8 being considered for the normal situation. If the VSC 10 is now at its capacitive limit, the TCR 8 reduces its inductive power, which eases the capacitive requirement imposed on the VSC 10. The interaction between the VSC 10 and the TCR 8 and vice versa is fluid. In this second method, the VSC 10 keeps the voltage fluctuations low most of the time, and the design of the TCR 8 or the SVC can be accordingly low.

In order to increase the reliability of the control system for reducing the voltage fluctuations, the system from FIG. 7 can be optimized with a further limiter, as illustrated in FIG. 8. Reference is generally made here again to the description of the system from FIG. 7. In particular, an additional VSC control unit 18′ is provided in the exemplary embodiment from FIG. 8 and also receives, as the input signal, the current measurement signal from the ammeter 16 and the voltage measurement signal from the voltmeter 19, like the VSC control unit 18. The output signal from VSC control unit 18 is again supplied to the limiter 27 here and the possibly limited signal is used to control the VSC 10. The parallel VSC control unit 18′ is now provided for the purpose of compensating for the peak reactive powers, the output signal from which control unit is supplied both to a second limiter 27′ and to a subtractor 28′. The output signal from the limiter 27′ is subtracted from the output signal from the VSC control unit 18′ in the subtractor 28′, and the resulting difference signal is used to control the TCR control unit 17 or the TCR 8. A power is therefore retrieved from the TCR 8 only when the value of the control signal from the VSC control unit 18′ is above the limit value of the limiter 27′. The limit values of the two limiters 27 and 27′ are preferably the same, but need not be. In this case too, the VSC 10 therefore manages the base load, while the TCR 8 assumes the peak load. However, the TCR and the VSC are controlled here by separate control units, as result of which the reliability can be increased.

According to the invention, the coordination of the operation of the SVC and the STATCOM is therefore optimized to the effect that the highest performance is achieved. at the lowest costs. The compensation performance of a large STATCOM is better than that of a conventional SVC system. Solutions which are based only on STATCOMs, however, are much more expensive. If a performance between one STATCOM and two STATCOMs is sufficient, the most cost-effective solution is to combine the SVC and the STATCOM. However, uncoordinated operation would reduce the performance.

Another exemplary embodiment for implementing the method according to the invention and the compensation device according to the invention is shown in FIG. 9. With respect to the description of FIG. 9, reference is again made to the description of all preceding figures where the same elements are mentioned. The following description concentrates only on the differences. In the further method according to FIG. 9, the VSC 10 compensates for that which the TCR does not manage to compensate for.

The compensation requirement is al above the performance of the TCR. Therefore, the VSC must always assume the compensation requirement which is not managed by the TCR. For this purpose, like in the preceding examples, a current measurement signal or current measured value is obtained from the ammeter 16, which measurement signal or measured value represents the current between the load 1 and the supply network 2 and is used here as the first current measurement signal (load current measurement signal). The TCR control unit 17 receives the first current measurement signal in unchanged form here as the current measurement signal. It therefore receives here, as input signals, the first current measurement signal directly from the ammeter 16 and the voltage measurement signal directly from the voltmeter 19.

In contrast, the VSC control unit 18 receives, as the current measurement signal, a sum of the first current measurement signal (load current measurement signal) from the first ammeter 16 and a second current measurement signal (TCR current measurement signal) from a second ammeter 29 which measures a current between the supply network 2 and the TCR 8. For this purpose, an adder 30 adds the first current measurement signal and the second current measurement signal and delivers the sum signal to the VSC control unit 18. The latter also obtains the voltage measurement signal from the voltmeter 19.

The TCR control system therefore compensates for the reactive load as well as it can. The TCR 8 opposes the capacitively acting passive filter circuit 15 with a corresponding inductive power. The VSC compensates for the remaining reactive power which the TCR does not manage to compensate for. For this purpose, the sum of the first current measurement signal (load current) and the second current measurement signal (TCR current) is supplied to the VSC control system. The compensation current from the VSC 10 then corresponds to the difference between the total (capacitive) filter current, which flows between the passive filter 15 and the supply network 2, and the (inductive) load current together with the (inductive) TCR current. The VSC must therefore only correct the difference which was not managed by the TCR 8. The performance of the method again falls into the band 24 from FIG. 6.

1-16. (canceled)

17. A method for reducing voltage fluctuations in a supply network which are caused by operating a load from the supply network, the method comprising:
measuring a current between the load and the supply network to thereby acquire a current measurement signal;
reducing the voltage fluctuations with the aid of a thyristor-controlled reactance (TCR), and
reducing the voltage fluctuations with the aid of a voltage source converter (VSC);
dividing the current measurement signal or a variable corresponding thereto into a first portion and a second portion based on a predefined absolute limit value;
controlling the TCR on a basis of the first portion of the current measurement signal; and
controlling the VSC on a basis of the second portion of the current measurement signal.

18. The method according to claim 17, wherein the predefined absolute limit value represents a cut-off frequency.

19. The method according to claim 18, wherein all frequencies of the first portion lie below the cut-off frequency and all frequencies of the second portion lie above the cut-off frequency.

20. The method according to claim 18, wherein the cut-off frequency lies between 0 and 8 Hz.

21. The method according to claim 20, wherein the cut-off frequency lies between 1 and 5 Hz.

22. The method according to claim 17, wherein the predefined limit value represents an intensity of the current or a power.

23. The method according to claim 22, which comprises forming the first portion with components of the current signal or of the variable corresponding thereto which are above the predefined limit value.

24. A compensation device for reducing voltage fluctuations in a supply network which are caused by operating a load from the supply network, the compensation device comprising:
a measuring device for measuring a current between the load and the supply network for acquiring a corresponding current measurement signal;
a thyristor-controlled reactance (TCR) for reducing the voltage fluctuations;
a voltage source converter (VSC) for reducing the voltage fluctuations;
a splitter device for dividing the current measurement signal or a variable corresponding thereto into a first portion and a second portion on a basis of a predefined absolute limit value;
a first control device for controlling said TCR on a basis of the first portion of the current measurement signal; and
a second control device for controlling said VSC on a basis of the second portion of the current measurement signal.

25. The compensation device according to claim 24, wherein said splitter device comprises a frequency splitter, and the predefined absolute limit value is a cut-off frequency of said frequency splitter.

26. The compensation device according to claim 24, wherein said splitter device comprises a limiter configured to use the predefined limit value to limit a control value for said VSC.

27. A method for reducing voltage fluctuations in a supply network which are caused by operating a load from the supply network, the method comprising:
measuring a current between the load and the supply network to acquire a corresponding first current measurement signal;
reducing the voltage fluctuations with the aid of a thyristor-controlled reactance (TCR);
reducing the voltage fluctuations with the aid of a voltage source converter (VSC);
measuring a current between the TCR and the supply network to acquire a corresponding second current measurement signal;
controlling the TCR on a basis of the first current measurement signal; and
controlling the VSC on a basis of the first and second current measurement signals.

28. The method according to claim 27, which comprises controlling the VSC on a basis of a sum of the first and second current measurement signals.

29. The method according to claim 27, which further comprises measuring a voltage of the supply network and also reducing the voltage fluctuations on a basis of the measured voltage.

30. A compensation device for reducing voltage fluctuations in a supply network which are caused by operating a load from the supply network, the compensation device comprising:
a first measuring device for measuring a current between the load and the supply network to acquire a corresponding first current measurement signal;
a thyristor-controlled reactance (TCR) for reducing the voltage fluctuations;
a voltage source converter (VSC) for reducing the voltage fluctuations;
a second measuring device for measuring a current between the TCR and the supply network to acquire a corresponding second current measurement signal;
a first control device for controlling the TCR on a basis of the first current measurement signal; and
a second control device for controlling the VSC on a basis of the first and second current measurement signals.

31. The compensation device according to claim 30, which further comprises an adder connected upstream of said second control device, and wherein the VSC is controlled on a basis of a sum of the first and second current measurement signals.

32. The compensation device according to claim 30, which further comprises a filter circuit connected in the supply network, said filter circuit being connected to interact with said TCR and said VSC in order to reduce the voltage fluctuations.

33. The compensation device according to claim 32, wherein said filter circuit is a passive filter, acting capacitively and being tuned to said TCR and said VSC.
